(19) United States
(12) Patent Application Publication
(10) Pub. No.: US 2007/0273713 A1
(43) Pub. Date: Nov. 29, 2007

(54) DRIVING A MATRIX DISPLAY

(75) Inventors: Robertus Hendricus Maria Wubben, Eindhoven (NL); Gerben Johan Hekstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,416

(22) PCT Filed: Mar. 25, 2005
(86) PCT No.: PCT/IB05/51036

§ 371 Date: Sep. 28, 2006

(30) Foreign Application Priority Data
Apr. 1, 2004 (EP) 04101361.6

(51) Int. Cl. G09G 5/10

(52) U.S. Cl. 345/690

(57) ABSTRACT

A driver (D) for a matrix display panel (1) with a pixel (Pk) comprising a first and a second sub-pixel (SP11, 12) both having an inertia, receives a first and second input signal (R, G) indicating a first and a second desired brightness transition (BT1, BT2) of the first and second sub-pixel (SP11, 12), respectively. The driver (D) supplies a first and a second drive signal (Ra, Ga) to the first and the second sub-pixel (SP11, 12), respectively. The first and a second drive signal (Ra, Ga) are supplied at a predetermined repetition rate, and levels of the first and the second drive signal (Ra, Ga) are limited between a minimum level (MI) and a maximum level (MA). The predetermined repetition rate may be the frame or line rate. The predetermined period is the reciprocal of the predetermined repetition rate. The driver (D) comprises: a detector (LV1) which detects whether the first drive signal (Ra) within the single predetermined period (Tf) would have to surpass the maximum level (MA) or to fall below the minimum level (MI) in order to compensate for the inertia of the first sub-pixel (SP11), and a level adapter (AC) which increases or decreases a level of the second drive signal (Ga) if is detected that the first drive signal (Ra) would have to surpass the maximum level (A) or fall below the minimum level (MI), respectively.

### FIELD OF THE INVENTION

The invention relates to a driver for a matrix display panel, to a display device comprising the driver, and to a method of driving a matrix display panel.

### BACKGROUND OF THE INVENTION

LCD (liquid crystal display) panels are increasingly used to display moving video content, for example in television receivers and computer monitors. However, the LC material in the current LCD panels is too slow to be able to display all desired pixel brightness transitions within a single frame time which results in blurred moving images. This problem can partly be mitigated with the well-known technique of overdrive. With overdrive, the pixels are driven with a higher level than the desired level. For example, if a pixel has to make a brightness transition from a low brightness value to a high brightness value, a level associated to the high brightness value has to be supplied to the pixel to obtain this high brightness value in the stable situation. However, due to the inertia of the LC material it may take several frames until the pixel has reached this high brightness value. In accordance with the overdrive technique, a higher level, also referred to as overdrive level, is supplied to the pixel than the associated level to force the LC material to speed up the transition such that the desired high value brightness is reached as fast as possible, preferable within one frame period. Once the pixel has reached the desired high value brightness, the overdrive level is replaced by the associated level to keep the brightness of the pixel equal to the desired brightness. Likewise, the level supplied to the pixel is selected temporary lower than the desired level to speed up a high-to-low transition.

The amount of overdrive is limited by the circuitry driving the LCD panel. In most LCD panels, full brightness corresponds to a pixel value of 255 and the pixel value cannot be larger than 255 (maximum electric field across the LC material). Hence, in case of a 0-to-255 transition, overdrive cannot be used because it would require a pixel value higher than 255. This clipping effect leads to a less effective overdrive and, hence, loss of contrast and blurred images. Likewise, the minimum pixel value is 0 (no electric field across the LC material). Going to negative values does not help, because the LC material reacts to the magnitude of the electric field, and not its sign.

### SUMMARY OF THE INVENTION

It is an object of the invention to provide a driver for a matrix display panel with an improved overdrive technique.

A first aspect of the invention provides a driver as claimed in claim 1. A second aspect of the invention provides a display device as claimed in claim 12. A third aspect of the invention provides a display apparatus as claimed in claim 13. A fourth aspect of the invention provides a method of driving a matrix display panel as claimed in claim 14. Advantageous embodiments are defined in the dependent claims.

The driver in accordance with the first aspect of the invention is for driving a matrix display panel which comprises a pixel which has a first and a second sub-pixel which both have inertia. For, example, the matrix display is a LCD, which has three sub-pixels per pixel, each one contributing with another primary color to the brightness and color of the pixel. But, the invention is also relevant for any other matrix display which has at least two sub-pixels per pixel and which sub-pixels have an inertness which means that it takes some time to reach a new optical state after the drive voltage supplied to the sub-pixel changed.

The driver receives a first and second input signal indicating a first and a second desired brightness transition of the first and second sub-pixel, respectively. The driver supplies a first and a second drive signal to the first and the second sub-pixel, respectively, at a predetermined repetition rate, for example, a frame rate. Thus, the brightness levels of the sub-pixels are updated with the frame rate. The levels of the first and the second drive signal are limited between a minimum level and a maximum level. Usually, the minimum level corresponds to a data value zero and the maximum level corresponds to the maximum data value the driver is able to generate. If the data comprises 8 bit data words, the maximum data value is 255.

The first desired brightness transition may be too large to be reached within one frame period even if the minimum or the maximum data value is applied to drive the first sub-pixel, while the second desired brightness transition is smaller than reachable within one frame period. Thus the second sub-pixel can be driven, depending on the situation with or without overdrive, to undergo the second desired brightness transition within one frame period.

The driver further comprises a detector which detects whether the first drive signal within the frame period would have to surpass the maximum level or to fall below the minimum level. Thus, starting with the present brightness level of the first sub-pixel and knowing that at the end of the frame period the first brightness transition should have been completed, it can be determined which drive signal is required to obtain the desired brightness at the end of the frame period. If the required drive signal remains between the minimum and maximum level, than the brightness transition can be completed within the frame period.

The driver further comprises a clipping compensator which, if is detected that the first drive signal would have to surpass the maximum or to fall below the minimum level at the end of the frame period, increases or decreases, respectively, the level of the second drive signal.

Thus in accordance with the invention, if a particular sub-pixel of a pixel is not able to perform the required brightness transition within a single frame period, the brightness of at least one of the other sub-pixels of the pixel is adapted by the driver to compensate for the brightness error made by the particular sub-pixel. Thus, with this approach it is possible to reach substantially the correct brightness transition of the pixel. However, although the brightness of the pixel is substantially equal to the desired brightness, its color deviates from the desired color. Nevertheless, it has been noted that the blur is much more noticeable than the color deviation.

If the pixel has more than two sub-pixels, it possible to select which one of the other sub-pixels should compensate for the brightness error of the particular sub-pixel. Alternatively, it is possible that more than one of the other sub-pixels compensate for the brightness error of the particular sub-pixel. Usually, the algorithm in accordance with the invention is applied in a matrix display device in which overdrive is used. Thus, for example, if the particular sub-pixel has to increase its brightness with a large step, the overdrive will cause the drive data to take the maximum value instead of the not possible higher value. Said in other words, the drive data is clipped to the maximum value. And, even then the desired brightness will not be reached within one field period. The difference or error between the desired brightness and the brightness reached after one field period is known. This error can be compensated by causing one of the other sub-pixels to increase its brightness above its desired brightness.

In current overdrive methods, the RGB pixel values are treated equally and independent from each other. The clipping of one of the color components does not affect the other color components. Especially, in a display with a scanning or flashing backlight, the luminance error due to the clipping is very visible as a post-ghost: a ghost image that follows the moving object on the screen.

It has to be noted that US2002/0149574A1 discloses that a problem in active matrix display devices, for example TFT-LCD's or AM-LCD's which are used in video applications or digital monitors, is the occurrence of motion artifacts such as motion blur. A movement within the image is vaguely displayed because the liquid crystal material requires a minimal time to reach a given final state defined by the drive voltages. This is obviated by making use of a pulsed backlight system in which, within a frame period, the full image is first addressed and, after the last picture line has been addressed, the light source is caused to emit a short intense light pulse.

However, the pixels associated with the line addressed as the first have had a longer time to reach their final stable state than the lines addressed at a later stage. Therefore, a signal processor increases the range of (possible) drive voltages (for example, via the data voltages) across the pixels (increasing “overdrive”) in the sequence of driving the rows of pixels. Although the pixels of different rows receive different overdrives, it is not disclosed that when one of the sub-pixels is unable to reach its desired brightness within one frame that another one of the sub-pixels of the pixel produces a higher or lower brightness than required to compensate for the brightness error made.

In the embodiment in accordance with the invention as claimed in claim 2, the matrix display panel has pixels with at least three sub-pixels. Usually, these sub-pixels have the three primary colors red, green, and blue, respectively. Alternatively, the pixels may comprise other colors for the sub-pixels or more than three sub-pixels. For example, a well known display has four sub-pixels per pixel with the colors red, green, blue and white.

Now, if of one of the sub-pixels the end-value at the end of the present predetermined period is higher than the maximum value or lower than the minimum value, the drive of this sub-pixel is clipped. The clipping compensator calculates the error caused in the brightness of the pixel comprising this clipping sub-pixel and adapts the brightness of one or more of the other sub-pixel(s) to decrease the error. Preferably, if possible, the brightness of the other sub-pixel(s) is adapted to completely compensate for the brightness error of the clipping pixels. If this is possible, consequently, the pixel has the desired brightness at a color which may deviate from the desired color. Because the error may be minimized by changing the level of all the other sub-pixels, all minimally, the resultant color deviation may be minimized.

In an embodiment in accordance with the invention as claimed in claim 3, the predetermined period is the frame period or the line period. This simplifies the algorithm used.

In an embodiment in accordance with the invention as claimed in claim 4, the driver further comprises a frame memory which, in a particular frame period further referred to as the present frame period, receives the first input signal and supplies a previous first input signal of a previous frame preceding the present frame period.

The detector comprises a first limit value determination circuit which receives the previous first input signal to determine, starting from a level of the previous first input signal a first obtainable minimum level and a first obtainable maximum level. The first obtainable minimum level is the level which is obtainable by supplying the minimum level to the first sub-pixel. The first obtainable maximum level is the level which is obtainable by supplying the maximum level to the first sub-pixel. The second obtainable minimum or maximum level is the level which is obtainable by supplying the minimum or maximum level, respectively, to the second sub-pixel. Due to the inertia of the sub-pixels, the obtainable minimum and maximum levels at the end of the present frame period depend on the present level of the sub-pixels at the start of the present frame period.

The clipping compensator receives the first obtainable minimum level, the first obtainable maximum level, and the second input signal to supply the second drive signal If is detected that the first drive signal surpasses the maximum or the minimum level, thus if the first drive signal is clipped, the clipping compensator increases or decreases, respectively, the level of the second drive signal with respect to the level of the second input signal.

The only difference between the embodiment in accordance with the invention as claimed in claim 6 and the embodiment as claimed in claim 4 is that now the drive signals instead of the input signals are stored in the frame memory. This embodiment has the advantage that it takes into account the signals which are actually displayed on the matrix display instead of the input signals. Consequently, the prediction of the obtainable minimum and maximum values will be improved.

In the embodiments in accordance with the invention as claimed in claims 5 or 7, the driver comprises the overdrive circuit which is arranged to receive the drive signals and the signals stored in the frame memory to supply overdriven drive signals. Such an overdrive circuit is well known. The overdrive circuit may receive gamma corrected drive signals if a display gamma corrector is present.

In the embodiment in accordance with the invention as claimed in claim 8, the level of the second drive signal is adapted to obtain together with the level of the clipped first drive signal a brightness transition of the first and the second sub-pixels which together is substantially identical to the average of the desired brightness transition of the first and second sub-pixels together.

In the embodiment in accordance with the invention as claimed in claim 9, the driver further comprises a source gamma corrector which receives the obtainable minimum level and the obtainable maximum level to supply a source gamma corrected minimum level and a source gamma corrected maximum level to the clipping compensator. If the source video signal is gamma pre-corrected, the clipping compensation performance is not optimal because the signal values and brightness do not have a linear relation. Therefore, preferably, the input signals are source gamma corrected to obtain a linear relation between the corrected input signals and the brightness.

In the embodiment in accordance with the invention as claimed in claim 10, the drive signals are corrected in a display gamma corrector to obtain corrected drive signals fitting the gamma of the display panel.

In the embodiment in accordance with the invention as claimed in claim 11, the matrix display panel has pixels with at least three sub-pixels. Usually, these sub-pixels have the three primary colors red, green, and blue, respectively. Alternatively, the pixels may comprise more than three sub-pixels. For example, a well-known display has four sub-pixels per pixel with the colors red, green, blue and white.

Now, all the input signals are stored in the frame memory, and of all the input signals is determined what the obtainable minimal and maximal values are at the end of the frame period, starting from the value stored in the frame memory. If of one (or more) of the sub-pixels the end value at the end of the present frame period would have to be higher than the maximum value or lower than the minimum value, the drive of the sub-pixel is clipped. The clipping compensator calculates the error caused in the brightness of the pixel comprising this clipping sub-pixel and adapts the brightness of the other non-clipping sub-pixel(s) to decrease the error. Preferably, if possible, the brightness of the non-clipping sub-pixel(s) is adapted to completely compensate for the brightness error of the clipping pixels. If this is possible, consequently, the pixel has the desired brightness at a color which deviates from the desired color.

Alternatively the drive signals are stored in the memory to be used to determine the obtainable minimum and maximum values. The obtainable minimum and maximum values are now determined with a higher accuracy because the actual starting brightness level of the sub-pixels are used instead of the input signals.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a display apparatus,

FIG. 2 show select signals and data signals for driving the sub-pixels of the matrix display device shown in FIG. 1,

FIG. 3 show the brightness of a sub-pixel as function of time for several drive signal levels,

FIG. 4 shows a prior art feed-forward overdrive circuit for a matrix display panel,

FIG. 5 show look up tables used in the prior art feed-forward overdrive circuit,

FIG. 6 shows a prior art feedback overdrive circuit for a matrix display panel,

FIG. 7 shows a block diagram of an embodiment of a matrix display device in accordance with the invention,

FIG. 8 shows a block diagram of another embodiment of a matrix display device in accordance with the invention,

FIG. 9 shows a block diagram of yet another embodiment of a matrix display device in accordance with the invention, and

FIG. 10 shows a flow chart elucidating an example of an algorithm for the clipping compensation in accordance with the invention.

### DETAILED DESCRIPTION OF THE PREFERRED EMBODIMENT

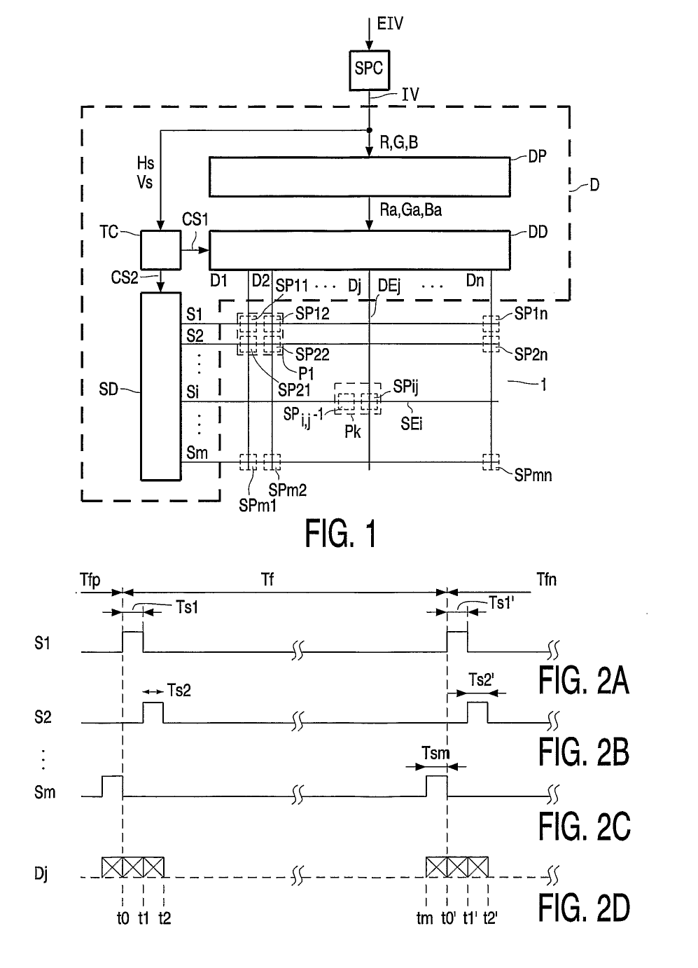

FIG. 1 shows a block diagram of a display apparatus. The display apparatus comprises signal processing circuitry SPC and a display device comprising a driver D an a matrix display panel 1. The matrix display panel 1 comprises sub-pixels SPij (SP11, SP12, SP21, SP22, SP1n, SP2n, SPm1, SPm2, SPmn) which are associated with intersecting select electrodes SEi and data electrodes DEj. The index i indicates the select electrode SEi involved, the index j indicates the data electrode DEj involved. By way of example only, the matrix display panel 1 shown in FIG. 1 has square sub-pixels SPij and pixels Pk which each comprise four sub-pixels SPij (the pixel P1 indicated comprises the sub-pixels SP11, SP12, SP21, and SP22). The sub-pixels SPij may have other dimensions such as oblong rectangles; the pixels Pk may comprise less or more than three sub-pixels SPij. The four sub-pixels SP11, SP12, SP21, SP22 of the pixel P1 may have the colors red, green, blue and white in any order. The indices i, j, and k are used to indicate the associated items in general, if a particular item is addressed, numbers are conferred to these indices.

The driver D comprises a select driver SD, a data driver DD, a data processor DP and a timing control circuit TC. The driver may be formed by one or more integrated circuits, or by one or more electronic modules comprising the one or more integrated circuits and optionally additional components. The signal processing circuitry converts an external input signal EIV to the format of the input video signal IV. The apparatus may be a television set, a monitor, a portable computer, a PDA or any other product with a display. The external input signal may be an antenna signal or any other signal from a video source, such as a computer or a DVD-player.

The data processor DP receives the input video signal IV which usually comprises the three input signals R, G, B which represent the colors red, green, and blue, respectively, and which together determine the brightness and color of the input video signal IV. It is assumed that these input signals R, G, B are digital signals of which the number of data pixels corresponds to the number of pixels Pk of the matrix display panel 1. If the video signal IV is an analog signal it has to be digitized first. If the number of data pixels is not equal to the number of pixels Pk a conversion has to be performed. Such a conversion usually is performed by a well known scaler. The data processor DP supplies drive signals Ra, Ga, Ba to the data driver DD.

The timing controller TC receives a horizontal synchronization signal Hs and a vertical synchronization signal Vs of the input video signal IV to supply a control signal CS1 to the data driver DD and a control signal CS2 to the select driver SD. The timing controller TC synchronizes the select driver SD and the data driver DD with the samples of the input video IV and also with respect to each other. The select driver SD supplies select signals Si (S1 to Sm) to the select electrodes SEi, usually to select the select electrodes SEi one by one. The data driver supplies the data signals Dj (D1 to Dn) via the data electrodes DEj to drive the sub-pixels SPij associated with the selected one of the select electrodes SEi.

FIG. 2 show select signals and data signals for driving the sub-pixels of the matrix display device. In all FIG. 2, the horizontal axis represents the time. FIG. 2A shows the select pulses S1 on the first one of the select electrodes SEi. FIG. 2B shows the select pulses S2 on the second one of the select electrodes SEi. FIG. 2C shows the select pulses Sm on the last one of the select electrodes SEi. FIG. 2D shows the data pulses Dj on the data electrodes DEj.

The present frame period Tf starts at the instant t0 and ends at the instant t0′. During the preceding frame period Tfp, the last select electrode is selected by the pulse Sm occurring just before the instant t0. The data Dj supplied to this last select electrode is schematically indicated by a cross. The cross indicates that the different data levels of the different data signals D1 to Dn are supplied in parallel and thus overlap each other in FIG. 2D. During the present frame period Tf, the first select electrode is selected from instant t0 to instant t1 due to the select signal S1 which has a high level during this first select period Ts1. In other displays, the select electrode may be selected with a low or negative level. During this first select period Ts1, the data D1 to Dn supplied in parallel to the data electrodes DEj will only influence the sub-pixels SP11 to SP1n associated with the first select electrode. The second select electrode is selected from instant t1 to instant t2 due to the select signal S2 which has a high level during the second select period Ts2. During this second select period Ts2, the data D1 to Dn only influences the sub-pixels SP21 to SP2n associated with the second select electrode. The last select electrode is selected from the instant tm to instant t0′ due to the select signal Sm which has a high level during the last select period Tsm. During this last select period Tsm, the data D1 to Dn only influences the sub-pixels SPm1 to SPmn associated with the last select electrode.

The next frame period Tfn starts at the instant t0′, the first select electrode is selected from instant t0′ to instant t1′ due to the select signal S1 which has a high level during the first select period Ts1′ of the next frame period Tfn. The second select electrode is selected from instant t1′ to instant t2′ due to the select signal S2 which has a high level during this second select period Ts2′ of the next frame period Tfn.

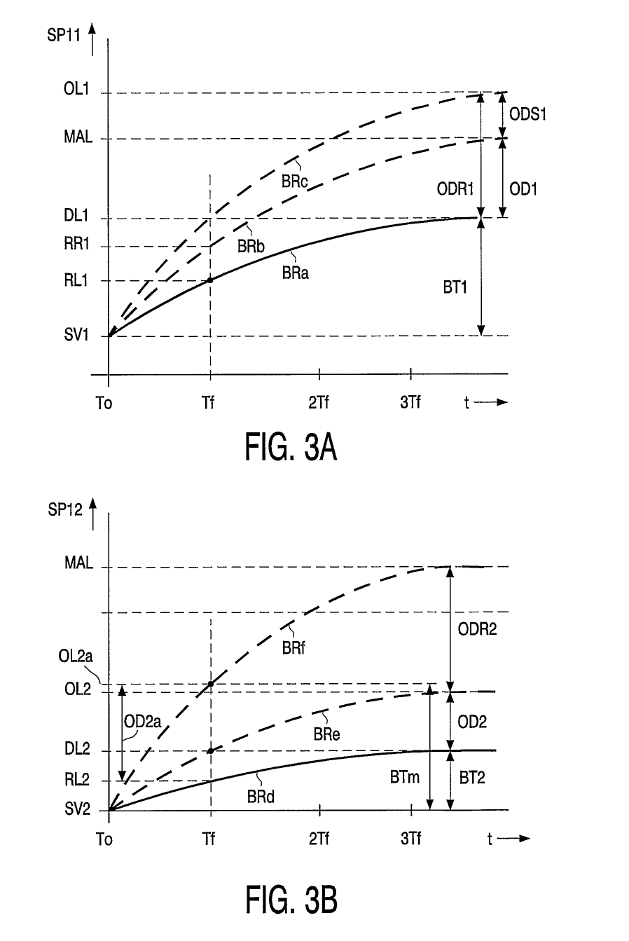

FIG. 3 show the brightness of a sub-pixel as function of time for several drive signal levels. FIG. 3A shows the brightness of a first one of the sub-pixels SPij of the pixel P1, this first one of the sub-pixels SPij is further referred to as the first sub-pixel SP 11, FIG. 3B shows the brightness of a second one of the sub-pixels SPij further referred to as the second sub-pixel SP12. Both the sub-pixels SPij are part of the same pixel PI.

In FIG. 3A, the brightness value of the sub-pixel SP11 at the instant To is SV1. The desired brightness level at the end of one frame period Tf, thus at the instant Tf is DL1. If no overdrive is used, the sub-pixel SP11 is driven with a drive signal which corresponds to the data indicating this desired brightness level DL1. Due to the inertness of the LC material, it will take several frame periods Tf until the sub-pixel SP11 has reached the desired brightness, see the line BRa. Now, in the end, near the instant 3Tf, the brightness of the sub-pixel SP11 reaches the desired brightness level DL1, but after one frame period Tf, at the instant Tf, the brightness level reached is only RL1. If within one frame period Tf, thus at the instant Tf the desired brightness level DL1 should be reached, an overdrive data signal corresponding with the brightness level OL1 should be supplied to the sub-pixel SP11. As shown by the dashed line BRc, now the desired brightness DL1 is reached at the instant Tf.

However, usually, the data signal is limited to a maximum value corresponding to a maximum voltage available to drive the sub-pixels SPij. In FIG. 3A it is assumed that with the maximum data signal in the stable situation the brightness changes as indicated by the dashed line BRb. Thus, at the end the maximum brightness MAL corresponding to a maximum drive signal level MA would be reached. Consequently, the brightness RR1 reached at the instant Tf lies in-between the brightness level RL1 reached without overdrive and the desired brightness level DL1 reached without clipped overdrive. Thus, due to the clipping of the drive signal and the resulting clipping of the data signal, it is not possible to reach the desired brightness level DL1 within one frame period Tf.

The difference between the level DL1 and the level OL1 is referred to as the required overdrive ODR1. The difference between the maximum possible level MAL and the level OL1 required to reach the desired brightness at the instant Tf is referred to as ODS1. This part ODS1 of the drive cannot be realized because the data signal cannot have a value higher than its maximum value. The difference between the maximum possible level MAL and the desired level DL1 is indicated by OD1, and the difference between the starting level SV1 and the desired level DL1 is called the desired brightness transition BT1.

FIG. 3B is very similar to FIG. 3A, now the sub-pixel SP12 has to make a brightness transition BT2 from the starting level SV2 to the desired level DL2. This brightness transition BT2 can be reached within one frame period with overdrive. As is clear from FIG. 3B, the sub-pixel SP12 may make a larger brightness transition. The maximum brightness transition possible is indicated by BTm. Because the sub-pixels SP11 and SP12 are part of the same pixel P1, the clipped overdrive of the pixel SP 11 which results in a too low brightness of the pixel P1 at the instant Tf, can be at least partly compensated by increasing the brightness of the sub-pixel SP12 at the instant Tf.

In FIG. 3B, the brightness value of the sub-pixel SP12 at the instant To is SV2. The desired brightness level at the end of one frame period, thus at the instant Tf is DL2. If no overdrive is used, the sub-pixel SP12 is driven with a drive signal which corresponds to the data indicating this desired brightness level DL2. Due to the inertness of the LC material, it will take several frame periods Tf until the sub-pixel SP12 has reached the desired brightness level DL2, see the line BRd. Thus, in the end, near the instant 3Tf, the brightness of the sub-pixel SP12 reaches the desired brightness level DL2. But after one frame period Tf, at the instant Tf, the brightness level reached is only RL2. If within one frame period Tf, thus at the instant Tf the desired brightness level DL2 should be reached, an overdrive data signal corresponding with the brightness level OL2 should be supplied to the sub-pixel SP12. As shown by the dashed line BRe, now the desired brightness DL2 is reached at the instant Tf.

Again, the data signal is limited to a maximum value corresponding to a maximum voltage available to drive the sub-pixels SPij. In FIG. 3B it is assumed that the maximum drive signal MA would be able to eventually reach the level corresponding to the brightness level MAL as indicated by the dashed line BRf. Consequently, at the instant Tf, the sub-pixel SP12 can reach the maximum brightness OL2a which is much higher than the desired brightness level DL2. Thus, the brightness of this sub-pixel SP12 at the instant Tf can be increased to maximally the level OL2a to at least partly compensate for the too low brightness of the sub-pixel SP11 at the instant Tf.

The difference between the level DL2 and the level OL2 is referred to as the required overdrive OD2. The difference between the maximum possible level MAL and the level OL2 is referred to as ODR2. This difference ODR2 can be used to increase the brightness of the sub-pixel SP12. The difference between the level RL2 and the level OL2a is indicated by OD2a.

Although both FIG. 3 show a brightness transition to a brighter state of the sub-pixels SP11 and SP12, a same clipping effect may occur for an opposite brightness transition. If the other one of the sub-pixels is not clipping, brightness compensation is possible. Of course, the compensation may also be possible if the brightness transitions of the sub-pixels SP11 and SP12 are opposite.

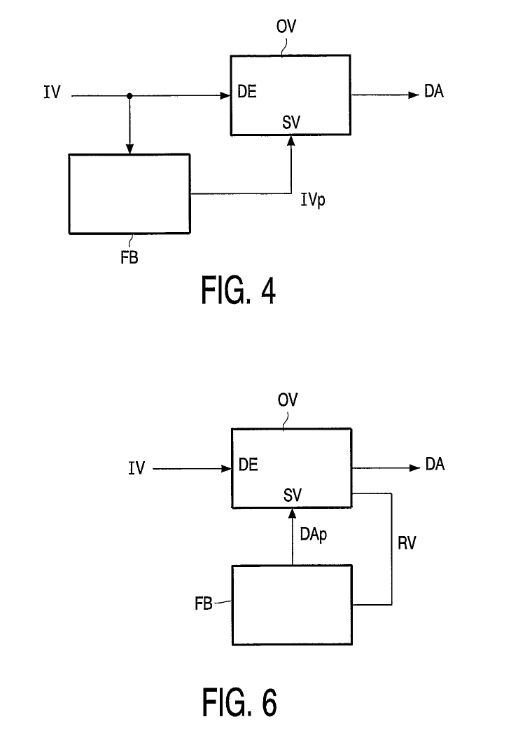

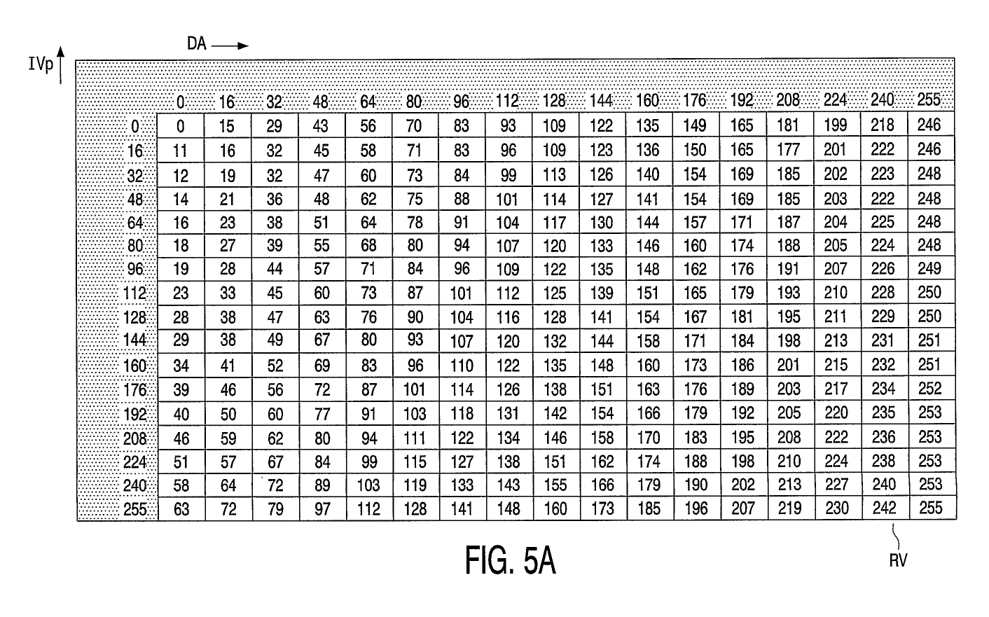

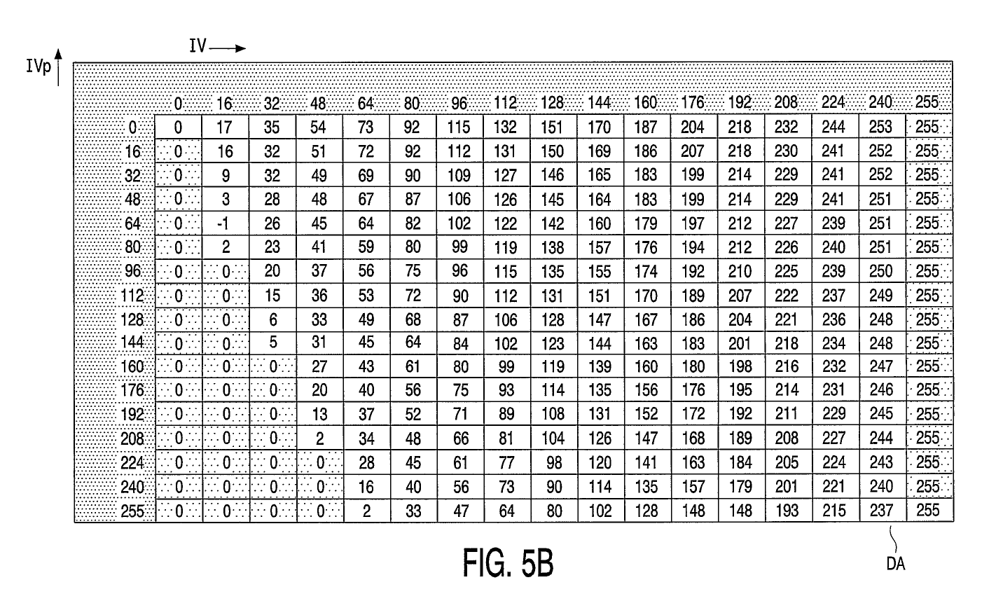

FIG. 4 shows a prior art feed-forward overdrive circuit for a matrix display panel. The input image signal IV is stored in a frame buffer FB and is supplied to a data input DE of an overdrive circuit OV. The frame buffer FB supplies the delayed input image signal IVp to a further data input SV of the overdrive circuit OV. The delayed input image signal IVp is the input signal IV delayed over one frame period Tf. Thus, the overdrive circuit OV receives for each sub-pixel SPij both the previous data IVp indicating the brightness level of the sub-pixel SPij during a previous frame period Tfp, and the present data IV indicating the brightness level the sub-pixel SPij should reach the present frame period Tf. The overdrive circuit OV uses the tables 1 and 2 as will be elucidated with respect to FIG. 5 to determine the level of the overdriven data DA.

FIG. 5 show look up tables used in the prior art feed-forward overdrive circuit.

FIG. 5A shows the table 1 which provides the response values RV of the sub-pixel SPij. The starting data level or the previous data IVp of the sub-pixel SPij is given in the left most column of the matrix. The actual drive data level DA is provided in the top row of the matrix. Starting from a starting data level IVp given in the left most column, for example the level 192, it can be found that if this sub-pixel SPij is driven with a particular level in the top row, for example the level 16, the resultant level 50 which will occur after one frame period Tf can be found in the cell corresponding with the intersection of the row starting at the left with 192 and the column starting at the top with 16. Thus, in this example, instead of the brightness transition corresponding to the data transition from 192 to 16, after one frame period, a brightness transition is made corresponding to the data transition from 192 to 50. The sub-pixel SPij will have a too high brightness level after one frame period. The brightness error made corresponds to a data difference of 34 which is a substantially amount if is realized that the data difference of 255 is the difference between a zero brightness and the maximum brightness.

FIG. 5B shows the table 2 which provides the overdrive values. Again, the starting data level IVp of the sub-pixel SPij is given in the left most column of the matrix. The desired drive data level IV is provided in the top row of the matrix. For the same example as given with respect to FIG. 5A, it can be found that if the start level is 192 and the desired level is 16, a drive signal DA of 0 has to be applied. The gray shading of the value 0 indicates that a lower value would be required to reach the desired level 16. Thus the overdrive value applied is clipped to the minimum value available (which is 0) and as can be found from table 1 the resultant level after one frame period will be 40 instead of 16.

In the prior art, each sub-pixel SPij is processed in the same manner. Thus if one of the sub-pixels SPij of a pixel Pk is clipping, the total brightness of this pixel Pk is too high or too low at the end of the frame period Tf This causes blur of the moving parts of the image. The invention compensates the brightness deviation by changing the brightness of a non-clipping sub-pixel SPij of the pixel Pk. This causes a color of the pixel P which deviates from the desired color. But, it appeared that the color deviation is less visible than the blur caused by the brightness deviation.

FIG. 6 shows a prior art feedback overdrive circuit for a matrix display panel. The overdrive circuit OV receives an input image signal IV at a data input DE, a start value DAp at a start value input SV, and supplies the overdriven data DA and a response value RV. The input image values IV represent the input image to be displayed. The overdriven data DA is supplied to one of the sub-pixels SPij of the display panel 1. The frame buffer FB receives the response value RV supplied by the overdrive circuit OV and supplies the response value RV delayed over one frame period Tf as the start value DAp to the start value input SV of the overdrive circuit OV. Thus, the overdrive circuit OV receives for each sub-pixel SPij both the start value or previous data DAp indicating the brightness level of the sub-pixel SPij during a previous frame period Tfp, and the input image values or the present data IV indicating the brightness level the sub-pixel SPij should reach during the present frame period Tf. Usually, the overdrive circuit OV uses two well known tables to determine both the level of the overdriven data DA and the value of the response value RV.

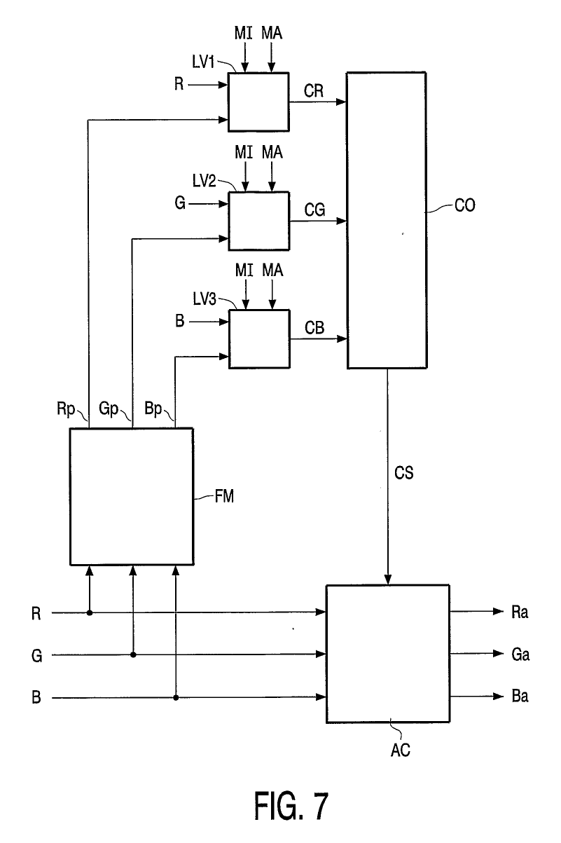

FIG. 7 shows a block diagram of an embodiment of a matrix display device in accordance with the invention. In this embodiment, the pixels Pk each have three sub-pixels SPij which have the colors red, green, and blue, respectively. The input signal IV comprises the color components R, G, B indicating the brightness of the triplets of sub-pixels with the colors red, green, and blue, respectively. The color components R, G, B are stored in the frame memory FM to obtain the delayed color components Rp, Gp, Bp which indicate the color components of the triplets of the previous frame period Tfp. The color components R, G, B are further supplied to a level adapting circuit AC which adapts the level of the color components R, G, B under control of a control signal CS to supply the adapted color components Ra, Ga, Ba to the display.

The detection circuit LV1 receives minimum and maximum values MI and MA, the color component R, and the delayed color component Rp to supply the control signal CR. The control signal CR indicates, starting from the delayed color component value Rp and knowing that after the frame period Tf the color component value R is desired, whether the overdrive results in clipping to the minimum value MI or the maximum value MA. If so, it is known that the brightness of the red sub-pixel deviates at the end of the frame period Tf from the desired brightness.

The detection circuit LV2 receives the minimum and maximum values MI and MA, the color component G, and the delayed color component Gp to supply the control signal CG. The control signal CG indicates, starting from the delayed color component value Gp and knowing that after the frame period Tf the color component value G is required, whether the overdrive results in clipping to the minimum value MI or the maximum value MA. If so, the brightness of the green sub-pixel deviates at the end of the frame period from the desired brightness.

The detection circuit LV3 receives the minimum and maximum values MI and MA, the color component B, and the delayed color component Bp to supply the control signal CB. The control signal CB indicates, starting from the delayed color component value Bp and knowing that after the frame period Tf the color component value B is required, whether the overdrive results in clipping to the minimum value MI or the maximum value MA. If so, the brightness of the blue sub-pixel deviates at the end of the frame period from the desired brightness. The minimum value M and the maximum value MA may be the same for each color component, but may also differ per color component.

The control signals CR, CG, GB are supplied to a control circuit CO which generates the control signal CS. Preferably, if clipping occurs, the control signal CS comprises the information indicating the clipping border against which the clipping occurs and the error made by the clipping. Or, if no clipping occurs the room available with respect to the minimum and maximum possible drive levels before clipping will occur. The control signal CS determines the adapted color components Ra, Ga, Ba based on the color components R, G, B. For example, if is detected that the delayed color component Rp and the color component R have values such that, due to the overdrive, a value of the adapted color component Ra should be higher than the maximum value MA, this adapted color component Ra is clipped to the maximum value. This determination may be based on the use of the tables of FIG. 5. It is now known, from these tables, which brightness deviation will occur at the end of the frame period Tf. This brightness deviation is compensated, preferably as much as possible, by controlling one of, or both the color components G and B such that adapted color components Ga and Ba are obtained which have a level or levels higher than required to reach their brightness levels as indicated by the color components G and B.

The circuit AC may digitally control the gain of the color components R, G, and B in a known manner, for example by multiplying the digital values of the color components R, G, B with a factor determined from the control signal CS. The control signal CS may comprise the multiplying factors. Instead of determining and applying the overdrive with the controller CO and the circuit AC, it is also possible to implement a prior art overdrive circuit which processes the adapted color signals Ra, Ga, and Ba. Instead of the color components R, G, B it is also possible to store the adapted color signals Ra, Ga, and Ba in the frame memory FM. This has the advantage that the values actually used to drive the sub-pixels SPij are also used to determine whether these values would fall below the minimum value MI or would surpass the maximum value MA.

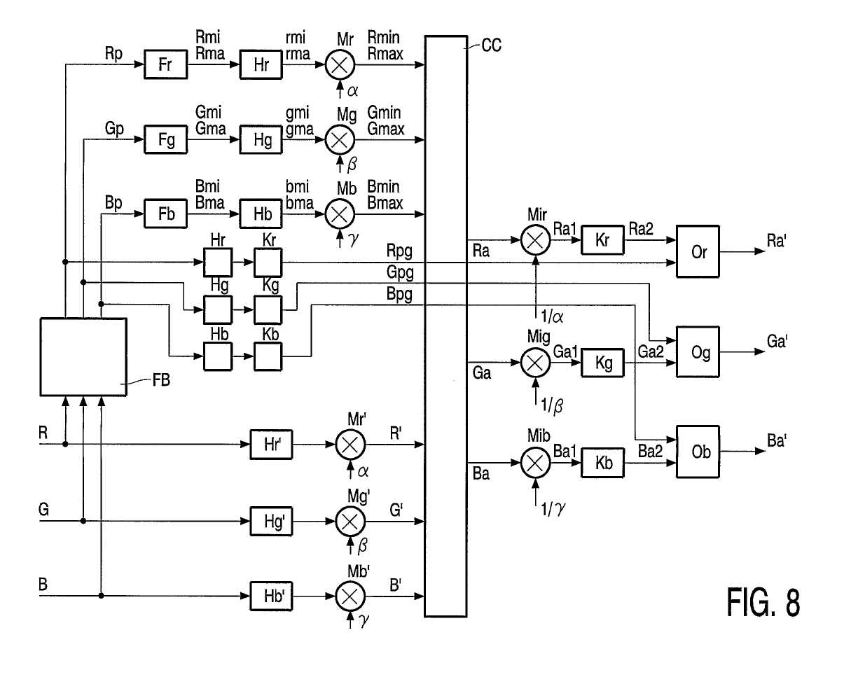

FIG. 8 shows a block diagram of another embodiment of a matrix display device in accordance with the invention.

A frame buffer FB stores the color component values R, G, B and supplies the previous color component values Rp, Gp, Bp representing the color component values of a previous frame.

The previous color component value Rp is supplied to a series arrangement of a function block Fr, a source gamma block Hr, and a digital multiplier Mr. The function block Fr outputs the minimum obtainable value Rmi during the current frame which is determined starting from the previous color component value Rp by supplying the minimum value, which is usually 0. The function block Fr further outputs the maximum obtainable value Rma which is determined starting from the previous color component value Rp by supplying the maximum value, which in a system with 8 bit data words is 255. This operation may be performed by using the table 1 of FIG. 5A by looking up for the concerned value of Rp (thus IVp in the table), which value of RV corresponds to DA=0 and DA=255, respectively. The optional source gamma block Hr corrects for the source gamma which may have been applied to the source images and supplies the minimum and maximum values rmi and rma which correspond linearly to the brightness of the sub-pixel SPij. The multiplier Mr multiplies the values rmi and rma with a factor a to obtain the corrected minimum and maximum values Rmin and Rmax.

The previous color component value Gp is supplied to a series arrangement of a function block Fg, a source gamma block Hg, and a digital multiplier Mg. The function block Fg outputs the minimum obtainable value Gmi which is determined starting from the previous color component value Gp by supplying the minimum value. The function block Fg further outputs the maximum obtainable value Gma which is determined starting from the previous color component value Gp by supplying the maximum value. The optional source gamma block Hg corrects for the source gamma which may have been applied to the source images to obtain minimum and maximum values gmi and gma which correspond linearly to the brightness of the sub-pixel SPij. The multiplier Mg multiplies the values gmi and gma with a factor β to obtain the corrected minimum and maximum values Gmin and Gmax.

The previous color component value Bp is supplied to a series arrangement of a function block Fb, a source gamma block Hb, and a digital multiplier Mb. The function block Fb outputs the minimum obtainable value Bmi which is determined starting from the previous color component value Bp by supplying the minimum value. The function block Fb further outputs the maximum obtainable value Bma which is determined starting from the previous color component value Bp by supplying the maximum value. The optional source gamma block Hb corrects for the source gamma which may have been applied to the source images to obtain minimum and maximum values bmi and bma which correspond linearly to the brightness of the sub-pixel SPij. The multiplier Mb multiplies the values bmi and bma with a factor γ to obtain the corrected minimum and maximum values Bmin and Bmax.

Usually, the luminance is defined by the equation Y=αR+βG+γB. Therefore, the multiplying with the factors α, β, and γ is performed to obtain the contributions of the color components values R, G, B to the luminance value Y.

The color component value R is further supplied to a series arrangement of an optional source gamma block Hr′ which has the same function as the source gamma block Hr, and to a multiplier Mr′ which has the same function as the multiplier Mr. This series arrangement supplies a corrected color component value R′.

The color component value G is further supplied to a series arrangement of an optional source gamma block Hg′ which has the same function as the source gamma block Hg, and to a multiplier Mg′ which has the same function as the multiplier Mg. This series arrangement supplies a corrected color component value G′.

The color component value B is further supplied to a series arrangement of an optional source gamma block Hb′ which has the same function as the source gamma block Hb, and to a multiplier Mb′ which has the same function as the multiplier Mb. This series arrangement supplies a corrected color component value B′.

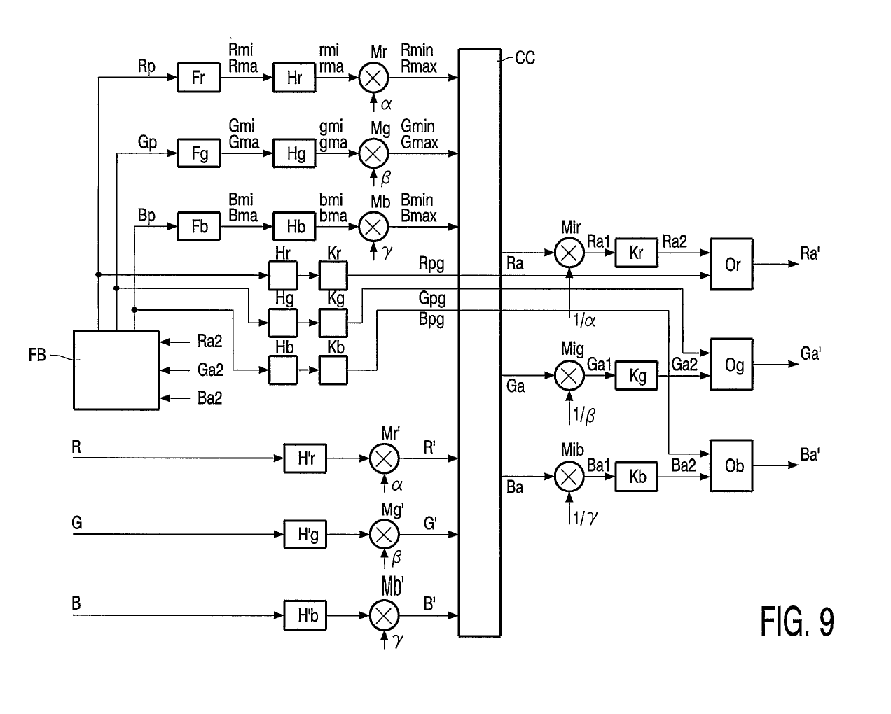

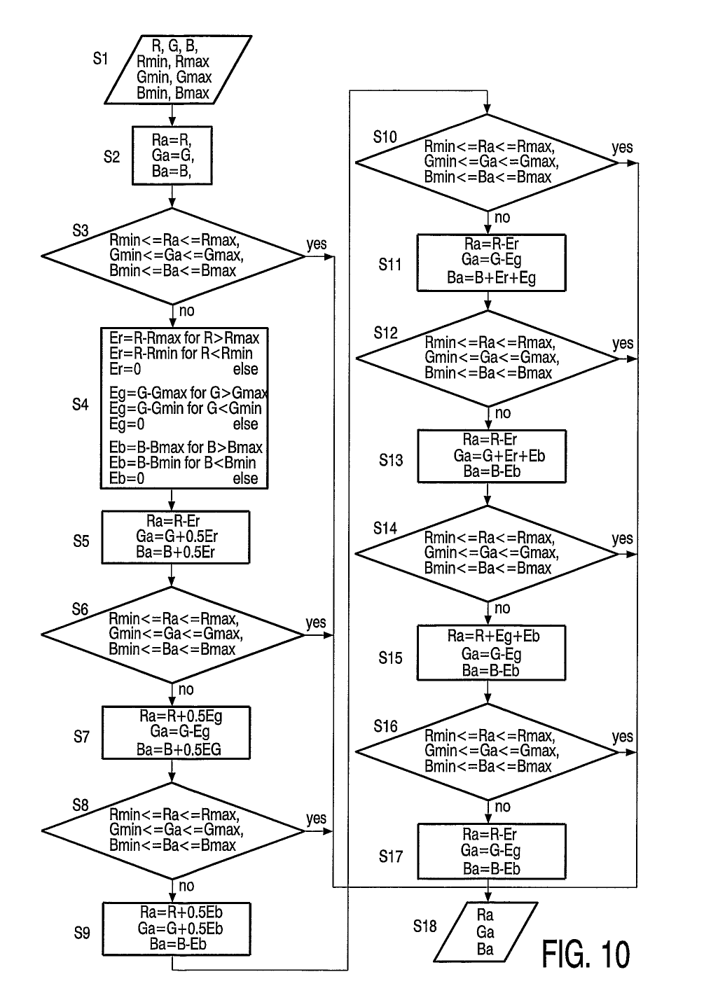

The clipping compensator CC receives the corrected minimum values Rmin, Gmin, and Bmin, the corrected maximum values Rmax, Gmax, and Bmax, and the corrected color component values R′, G′ and B′ to generate the adapted color component values Ra, Ga, and Ba, respectively. The clipping compensator CC, for example, performs the algorithm elucidated with respect to FIG. 9. In short, by way of example for the green color component G, if is detected that the corrected green color component value G′ has a value which is within the range indicated by the values Gmin and Gmax, this value of the corrected green color component G′ can be obtained within one frame period Tf and no correction of the brightness of the pixel Pk is required: the value of Ga is identical to G′ (if none of the other color components of the pixel Pk is clipping). If is detected that the corrected green color component value G′ has a value which is not within the range indicated by the values Gmin and Gmax, this value of G′ has to be clipped to either the value Gmin or Gmax, whichever is closest. Thus now, the value of Ga is equal to Gmin or Gmax. Consequently, the desired brightness of the green sub-pixel SPij can not be obtained within one frame period and the clipping compensator CC tries to compensate for the resultant brightness deviation of the pixel Pk by adapting at least one of the corrected color components R′ or B′.

The adapted color component value Ra is supplied to a series arrangement of a multiplier Mir, an optional display gamma corrector Kr, and an overdrive circuit Or. The multiplier Mir multiplies the color component value Ra with a factor 1/α to supply the value Ra1. The display gamma corrector Kr receives the value Ra1 and supplies the value Ra2 which is corrected for the non-linear transfer function of the display panel 1. The overdrive circuit Or, which as such is well known, receives the value Ra2 and the previous color component value Rp to supply the red output signal Ra′ which is used to drive the red sub-pixel SPij. Optionally, if the source gamma correction Hr, Hr′ and/or the display gamma correction Kr is present in the other branches, the corresponding same gamma correction has to be present to convert the previous color component value Rp into a gamma corrected previous color component value Rpg which is supplied to the overdrive circuit Or.

The adapted color component value Ga is supplied to a series arrangement of a multiplier Mig, an optional display gamma corrector Kg, and an overdrive circuit Og. The multiplier Mig multiplies the color component value Ga with a factor 1/β to supply the value Ga1. The display gamma corrector Kg receives the value Ga1 and supplies the value Ga2 which is corrected for the non-linear transfer function of the display. The overdrive circuit Og receives the value Ga2 and the previous color component value Gp to supply the green output signal Ga′ which is used to drive the green sub-pixel SPij. Optionally, if the source gamma correction Hg and/or the display gamma correction Kg is present in the other branches, the corresponding same gamma correction has to be present to convert the previous color component value Gp into a gamma corrected previous color component value Gpg which is supplied to the overdrive circuit Og.

The adapted color component value Ba is supplied to a series arrangement of a multiplier Mib, an optional display gamma corrector Kb, and an overdrive circuit Ob. The multiplier Mib multiplies the color component value Ba with a factor 1/γ to supply the value Ba1. The display gamma corrector Kb receives the value Ba1 and supplies the value Ba2 which is corrected for the non-linear transfer function of the display. The overdrive circuit Ob receives the value Ba2 and the previous color component value Bp to supply the blue output signal Ba′ which is used to drive the blue sub-pixel SPij. Optionally, if the source gamma correction Hb and/or the display gamma correction Kb is present in the other branches, the corresponding same gamma correction has to be present to convert the previous color component value Bp into a gamma corrected previous color component value Bpg which is supplied to the overdrive circuit Ob.

The multipliers Mir, Mig, and Mib change the linear light values into brightness values according to the luminance Y which is Y=αR+βG+γB.

FIG. 9 shows a block diagram of yet another embodiment of a matrix display device in accordance with the invention. This embodiment is almost identical to the embodiment described with respect to FIG. 8. The same items refer to the same functions or signals, and need not be elucidated again. The only difference is that the frame buffer FB now receives the values Ra2, Ga2, Ba2 instead of the color component values R, G, B. It is also possible to use the drive values Ra′, Ga′, Ba′ instead of the color component values R, G, B. Because the values Ra2, Ga2, Ba2 or Ra′, Ga′, Ba′ are a better representation of what is displayed on the display panel 1 than the color component values R, G, B, the clipping compensator CC will operate more accurate.

FIG. 10 shows a flow chart elucidating an example of an algorithm for the clipping compensation in accordance with the invention.

In step S1, the values of the color components R, G, B are received and the minimum values Rmin, Gmin, Bmin, and the maximum values Rmax, Gmax, Bmax are determined from the previous values of the color components Rp, Gp, Bp, which are the values of the color components R, G, B of the previous frame. The minimum values Rmin, Gmin, Bmin can be found in table 1 (FIG. 5A) by looking up for the concerned previous values of the color components Rp, Gp, Bp which value will be reached if the drive value is zero. The maximum values Rmax, Gmax, Bmax can be found in table 1 (FIG. 5A) by looking up for the concerned previous values of the color components Rp, Gp, Bp which values will be reached if the drive value is maximum, which in this example is the value 255.

In step S2, the adapted color component values Ra, Ga, and Ba are preset to the values of the color components R, G, B. If none of the color components R, G, B is expected to clip, the adapted component values Ra, Ga, Ba should have the values of the color components R, G, B.

In step S3, it is checked whether the adapted color component value Ra (which in the previous step was made equal to the value of R) is in between the minimum value Rmin and the maximum value Rmax, whether the adapted color component value Ga is in between the minimum value Gmin and the maximum value Gmax, and whether the adapted color component value Ba is in between the minimum value Bmin and the maximum value Bmax. If all these conditions are true, none of the drive values Ra, Ga, Ba is expected to clip, and no adaptation of the values of the color components R, G, B is required. Therefore, in step S18 the values Ra, Ga, and Ba which are identical to the values of the color components R, G, B are outputted to the display panel 1, usually via the data driver DD. If one of these conditions is false, at least one of the color clips and the algorithm proceeds with step S4.

In step S4 the following situations are detected and the mentioned actions are taken. If the value of R is higher than Rmax, a variable Er is set to the difference R−Rmax. If the value of R is lower than Rmin, the variable Er is set to the difference R−Rmin. This difference Er is an indication for the brightness error made by clipping the red color component, and can be used to correct the brightness of the other sub-pixels SPij of the pixel Pk. For all other values of R, the variable Er is set to zero. If no clipping occurs, no brightness error will be made and no brightness correction in the other sub-pixels SPij of the pixel Pk is required. If the value of G is higher than Gmax, a variable Eg is set to the difference G−Gmax. If the value of G is lower than Gmin, the variable Eg is set to the difference G−Gmin. For all other values of G, the variable Eg is set to zero. If the value of B is higher than Bmax, a variable Eb is set to the difference B−Bmax. If the value of B is lower than Bmin, the variable Eb is set to the difference B−Bmin. For all other values of B, the variable Eb is set to zero.

In step S5, the value of Ra is set to the difference R−Er, the value of Ga is set to the sum G+0.5 Er, and the value of Ba is set to B+0.5 Er. Thus, if the red color clips, the brightness deviation of the pixel Pk involved is corrected by adapting the brightness of the two other sub-pixels SPij of the pixel Pk, each with half the error Er. This only works if after the correction none of the two corrected values Ga and Ba clip. The algorithm may be made much more complex. The amounts of correcting the blue color component B and the green color component G may be different. Different amounts of correction may be relevant if a particular color deviation is preferred to minimize the visibility of the color deviation. Different amounts of correction may be required if the correction of one of the color components G or B causes clipping while the other one may be corrected more before clipping occurs.

In step S6, the same checks are performed as in step S3. If now none of the colors clip, indeed the clipping occurred in the red channel, and no clipping is introduced by correcting the other colors. The values found in step S5 will be outputted in step S18. If at least one of the conditions is false, it was either not the red channel which was clipping, or one of the corrected colors is now clipping.

In step S7, the value of Ga is set to the difference G−Eg, the value of Ra is set to the sum R+0.5 Eg, and the value of Ba is set to B+0.5 Eg. Thus, if the green color clips, the brightness deviation of the pixel Pk involved is corrected by adapting the brightness of the two other sub-pixels SPij of the pixel Pk. This only works if after the correction none of the two corrected values Ra and Ba clip. Again, other algorithms are possible taking the resulting color deviation and/or clipping of the other sub-pixels SPij into account.

In step S8, the same checks are performed as in step S3. If now none of the colors clip, indeed the clipping occurred in the green channel, and no clipping is introduced by correcting the other colors. The values found in step S7 will be outputted in step S 18. If at least one of the conditions is false, it was either not the green channel which was clipping, or one of the corrected colors is now clipping.

In step S9, the value of Ba is set to the difference B−Eb, the value of Ra is set to the sum R+0.5 Eb, and the value of Ga is set to G+0.5 Eb. Thus, if the blue color clips, the brightness deviation of the pixel Pk involved is corrected by adapting the brightness of the two other sub-pixels SPij of the pixel Pk. This only works if after the correction none of the two corrected values Ra and Ga clip. Again, other algorithms are possible taking the resulting color deviation and/or clipping of the other sub-pixels SPij into account.

In step S10, the same checks are performed as in step S3. If now none of the colors clip, indeed the clipping occurred in the blue channel, and no clipping is introduced by correcting the other colors. The values found in step S9 will be outputted in step S18. If at least one of the conditions is false, it was either not the blue channel which was clipping, or one of the corrected colors is now clipping.

In step S11, the value of Ra is set to the difference R−Er, the value of Ga is set to the difference G−Eg, and the value of Ba is set to G+Er+Eg. This would be the correct compensation if both the red and the green channel are clipping. The compensation is only perfect if after the correction the blue channel does not clip.

In step S12, the same checks are performed as in step S3. If now none of the colors clip, indeed the clipping occurred in both the red and the green channel, and no clipping is introduced by correcting the blue color. The values found in step S11 will be outputted in step S18. If at least one of the conditions is false, it were either not the red and green channels which were clipping, or now the blue channel is clipping. Again, other algorithms are possible, it may be accepted that it is not possible to completely compensate the brightness in the blue channel for the brightness error made in both the red and the green channel.

In step S13, the value of Ra is set to the difference R−Er, the value of Ga is set to the sum G+Er+Eb, and the value of Ba is set to the difference B−Eb. This would be the correct compensation if both the red and the blue channel are clipping. The compensation is only perfect if after the correction the green channel does not clip. Again, it would be possible to accept a partly compensation.

In step S14, the same checks are performed as in step S3. If now none of the colors clip, indeed the clipping occurred in both the red and the blue channel, and no clipping is introduced by correcting the green color. The values found in step S13 will be outputted in step S18. If at least one of the conditions is false, it were either not the red and blue channels which were clipping, or now the green channel is clipping.

In step S15, the value of Ra is set to R+Eg+Eb, the value of Ga is set to G−Eb, and the value of Ba is set to the difference B−Eb. This would be the correct compensation if both the green and the blue channel are clipping. The compensation is only perfect if after the correction the red channel does not clip. Again, it would be possible to accept a partly compensation.

In step S16, the same checks are performed as in step S3. If now none of the colors clip, indeed the clipping occurred in both the green and the blue channel, and no clipping is introduced by correcting the red color. The values found in step S15 will be outputted in step S18. If at least one of the conditions is false, all three colors were clipping or an optimal correction is not possible. Now, in step S17 the value of Ra is set to R−Er, the value of Ga is set to G−Eg, and the value of Ba is set to B−Eb.

It is clear that the above algorithm may be altered without departing from the invention. For example the condition whether a previous color component value Rp is within the range of the values Rmin and Rmax may be checked for each color separately. Then dependent on the situation detected, the required clipping compensation can be determined. It is also possible to correct the brightness error made due to the clipping error of the clipping sub-pixels SPij by correcting the levels of the other sub-pixels with different amounts. However, preferably, the error is spread evenly over the other colors to obtain a minimal color deviation. But this might not always possible if one if the other colors clips due to the correction.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driver (D) for a matrix display panel with a pixel (Pk) comprising a first and a second sub-pixel (SP11, SP12) both having an inertia, to supply a first and a second drive signal (Ra, Ga) to the first and the second sub-pixel (SP11, SP12), respectively, at a predetermined repetition rate in response to a first and second input signal (R, G) indicating a first and a second desired brightness transition (BT1, BT2) of the first and second sub-pixel (SP11, SP12), respectively, the driver (D) comprising:
means (LV1; CC, Fr, Fg, Fb) for detecting whether the first drive signal (Ra) would have to surpass a maximum level (MA) or to fall below a minimum level (MI) in order to compensate for the inertia of the first sub-pixel (SP11) so as to enable the first sub-pixel (SP11) to substantially complete the first desired brightness transition (BT1) within a single predetermined period (Tf; TS1) being the reciprocal of the predetermined repetition rate, and
means (AC, CO; CC) for adapting the first and/or the second drive signals (Ra, Ga) to compensate for the inertia and for increasing or decreasing a level of the second drive signal (Ga) if is detected that the first drive signal (Ra) would have to surpass the maximum level (MA) or to fall below the minimum level (MI), respectively.

2. A driver as claimed in claim 1, wherein the pixel (Pk) further comprises a third sub-pixel (SP21), the driver (D) being arranged for further receiving a third input signal (B) indicating a third desired brightness transition of the third sub-pixel (SP21) to supply a third drive signal (Ba) to the third sub-pixel (SP21) at the predetermined repetition rate,
the means (AC, CO; CC) for increasing or decreasing the level of the second drive signal (Ga) comprises a clipping compensator (CC) for receiving a first obtainable minimum level (Rmi) of the first drive signal (Ra), a first obtainable maximum level (Rma) of the first drive signal (Ra), the second input signal (G), and the third input signal (B) to supply the second drive signal (Ga) and the third drive signal (Ba) wherein at least one of the levels of the second and third drive signal (Ga, Ba) is increased or decreased with respect to the level of the second and third input signal (G, B), respectively, if is detected that the first drive signal (Ra) would have to surpass the maximum level (MA) or to fall below the minimum level (MI).

3. A driver as claimed in claim 1, wherein the predetermined period (Tf; TS1) is a frame period (Tf) or a line period (TS1).

4. A driver as claimed in claim 3, further comprising
a frame memory (FM; FB) for storing the first input signal (R) to supply a previous first input signal (Rp) of a previous frame,
the means (LV1; CC, Fr, Fg, Fb) for detecting whether the first drive signal (Ra) would have to surpass the maximum level (MA) or to fall below the minimum level (MI) comprising a first limit value determination circuit (Fr) for receiving the previous first input signal (Rp) to determine, starting from a level of the previous first input signal (Rp) a first obtainable minimum level (Rmi) being obtainable by supplying the minimum level (MI) to the first sub-pixel (SP11), and a first obtainable maximum level (Rma) being obtainable by supplying the maximum level (MA) to the first sub-pixel (SP11), and
the means (AC, CO; CC) for increasing or decreasing the level of the second drive signal (Ga) comprising a clipping compensator (CC) for receiving the first obtainable minimum level (Rmi), the first obtainable maximum level (Rma), and the second input signal (G) to supply the second drive signal (Ga) having a level being increased or decreased with respect to the level of the second input signal (G), respectively, if is detected that the first drive signal (Ra) would have to surpass the maximum level (MA) or to fall below the minimum level (MI).

5. A driver as claimed in claim 4, wherein the frame memory (FM; FB) is arranged for further storing the second input signal (G) to supply a previous second input signal (Gp) of the previous frame, and wherein the driver (D) further comprises an overdrive circuit (Og) for receiving the second drive signal (Ga) and the previous second input signal (Gp) to supply an overdriven second drive signal (Ga′) to the second sub-pixel (SP12).

6. A driver as claimed in claim 3, further comprising
a frame memory (FB; FM) for storing the first drive signal (Ra) to supply a previous first drive signal (Rp) of a previous frame, and the second drive signal (Ga) to supply a previous second drive signal (Gp) of a previous frame,
the means (LV1; CC, Fr, Fg, Fb) for detecting whether the first drive signal (Ra) would have to surpass the maximum level (MA) or to fall below the minimum level (MI) comprising a first limit value determination circuit (Fr) for receiving the previous first drive signal (Rp) to determine, starting from a level of the previous first drive signal (Rp) a first obtainable minimum level (Rmi) being obtainable by supplying the minimum level (MI) to the first sub-pixel (SP11), and a first obtainable maximum level (Rma) being obtainable by supplying the maximum level (MA) to the first sub-pixel (SP11), and
the means (AC, CO; CC) for increasing or decreasing the level of the second drive signal (Ga) comprising a clipping compensator (CC) for receiving the first obtainable minimum level (Rmi), the first obtainable maximum level (Rma), and the second input signal (G) to supply the second drive signal (Ga) having a level being increased or decreased with respect to the level of the second input signal (G) if is detected that the first drive signal (Ra) would have to surpass the maximum level (MA) or to fall below the minimum level (MI), respectively.

7. A driver as claimed in claim 6, further comprising an overdrive circuit (Og) for receiving the second drive signal (Ga) and the previous second drive signal (Gp) to supply an overdriven second drive signal (Ga′) to the second sub-pixel (SP12).

8. A driver as claimed in claim 1, wherein the means (AC, CO; CC) for increasing or decreasing the level of the second drive signal (Ga) is arranged for changing the level of the second drive signal (Ga) to obtain together with a level of the first drive signal (Ra) a brightness transition of the first and the second sub-pixels (SP11, SP12) together being substantially identical to the desired brightness transition of the first and second sub-pixels (SP11, SP12) together.

9. A driver as claimed in claim 4, further comprising a source gamma corrector (Hr) for receiving the obtainable minimum level (Rmi) and the obtainable maximum level (Rma) to supply a source gamma corrected minimum level (rmi) and a source gamma corrected maximum level (rma) to the clipping compensator (CC).

10. A driver as claimed in claim 4, further comprising a display gamma corrector (Kr) for receiving the first drive signal (Ra) to supply a corrected first drive signal (Ra2).

11. A driver as claimed in claim 4, wherein the pixel (Pk) further comprises a third sub-pixel (SP21), the driver (D) being arranged for further receiving a third input signal (B) indicating a third desired brightness transition of the third sub-pixel (SP21) to supply a third drive signal (Ba) to the third sub-pixel (SP21) at a frame rate, being the reciprocal of the frame period (Tf),
the frame memory (FB) is arranged for further storing the second input signal (G) and the third input signal (B) to supply a previous second input signal (Gp) and a previous third input signal (Bp), respectively,
the means (LV1; CC, Fr, Fg, Fb) for detecting further comprises:
a second limit value determination circuit (Fg) for receiving the previous second input signal (Gp) to determine, starting from a level of the previous second input signal (Gp) a second obtainable minimum level (Gmi) being obtainable by supplying the minimum level (MI) to the second sub-pixel (SP12), and a second obtainable maximum level (Gma) being obtainable by supplying the maximum level (MA) to the second sub-pixel (SP12), and
a third limit value determination circuit (Fb) for receiving the previous third input signal (Bp) to determine, starting from a level of the previous third input signal (Bp) a third obtainable minimum level (Bmi) being obtainable by supplying the minimum level (MI) to the third sub-pixel (SP21), and a third obtainable maximum level (Bma) being obtainable by supplying the maximum level (MA) to the third sub-pixel (SP21), and
the clipping compensator (CC) is arranged for further receiving the third input signal (Bp) to supply the third drive signal (Ba), wherein at least one level of the second and third drive signal (Ga, Ba) is increased or decreased with respect to the level of the second and third input signal (G, B), respectively, if is detected that the first drive signal (Ra) would have to surpass the maximum level (MA) or to fall below the minimum level (MI).

12. A display device comprising the driver (D) as claimed in claim 1, and the display panel (1).

13. A display apparatus comprising the display device as claimed in claim 12, and signal processing circuitry (SPC).

14. A method of driving a matrix display panel comprising a pixel (Pk) having a first and a second sub-pixel (SP11, SP12) both having an inertia, the method comprising:
receiving (D) a first and second input signal (R, G) indicating a first and a second desired brightness transition (BT1, BT2) of the first and second sub-pixel (SP11, SP12), respectively, for supplying (D) a first and a second drive signal (Ra, Ga) to the first and the second sub-pixel (SP11, SP12), respectively, at a predetermined repetition rate, the step of receiving and supplying (D) comprising:
detecting (LV1; CC, Fr, Fg, Fb) whether the first drive signal (Ra) would have to surpass a maximum level (MA) or to fall below a minimum level (MI) in order to compensate for the inertia of the first sub-pixel (SP11) so as to enable the first pixel (SP11) to substantially complete the first desired brightness transition (BT1) within a single predetermined period (Tf) being the reciprocal of the predetermined repetition rate, and
increasing or decreasing (AC, CO; CC) a level of the second drive signal (Ga) if is detected that the first drive signal (Ra) would have to surpass the maximum level (MA) or to fall below the minimum level (MI), respectively.
